(19) United States
(12) Patent Application Publication
(10) Pub. No.: US 2026/0217889 A1
(43) Pub. Date: Jul. 30, 2026

(54) ETHYLENE COPOLYMERS FOR HYDROCARBON APPLICATIONS

(71) Applicant: Dow Global Technologies LLC, Midland, MI (US)

(72) Inventors: Roxanne M. Jenkins, Missouri City, TX (US); Amanda M. Goodman, Missouri City, TX (US); Stacey Camacho, Lake Jackson, TX (US)

(21) Appl. No.: 19/145,968

(22) PCT Filed: Mar. 27, 2024
(86) PCT No.: PCT/US2024/021667

§ 371 Date: Jul. 7, 2025

Related U.S. Application Data
(60) Provisional application No. 63/456,319, filed on Mar. 31, 2023.

(51) Int. Cl. C08F 220/32; C10L 1/04; C10L 1/196; C10L 10/16

(52) U.S. Cl. CPC C08F 220/325; C10L 1/04; C10L 1/1963; C10L 10/16

(57) ABSTRACT

Embodiments of the present disclosure are directed towards a composition that includes a hydrocarbon mixture having paraffin wax and at least one reactive moiety, and an ethylene acrylic ester terpolymer having a moiety reactive with at least one reactive moiety in the hydrocarbon mixture. For the embodiments, the ethylene acrylic ester terpolymer is formed from (A) a first monomer of ethylene, (B) a second monomer selected from the group consisting of vinyl acetate, alkyl acrylic esters, alkyl (meth)acrylic esters and combinations thereof, and (C) a third monomer having the moiety reactive with at least one reactive moiety in the hydrocarbon mixture, the third monomer selected from the group consisting of maleic anhydride, maleic acid diesters, glycidyl acrylate, glycidyl methacrylate, glycidyl vinyl ether and combinations thereof.

### FIELD OF DISCLOSURE

Embodiments of the present disclosure are directed to ethylene copolymers and in particular ethylene copolymers for hydrocarbon applications.

### BACKGROUND

Petroleum and refined petroleum products (e.g., crude oils, condensates fuel oil, middle distillates, diesel fuel, and heavy fuel oil) are complex mixtures of various compounds including paraffinic, olefinic, and aromatic hydrocarbons, as well as resins and asphaltenes. The composition of these mixtures can have a strong effect on their flow characteristics, especially at low temperatures. For example, paraffin wax molecules can precipitate at room temperature or at low temperatures, depending on the petroleum or the refined petroleum product composition. Once precipitated, the paraffin wax can cause an increase in the viscosity of the petroleum and/or paraffin deposition leading to clogged pipelines, pumps, engine filters, etc. making transport, storage and use of these fluids challenging.

The temperature at which this precipitation can occur depends upon the composition of the petroleum or refined petroleum products and their respective pour point temperature. The pour point (PP) of a crude oil, or a petroleum product, is the lowest temperature at which the oil will pour or flow when it is cooled, without stirring, under standard cooling conditions. The pour point represents the lowest temperature at which oil is capable of flowing under gravity. Petroleum containing high amounts of paraffin shows high PP temperatures due to paraffin precipitation and deposition. Paraffin precipitation can cause an increase in the viscosity of petroleum and flow restrictions and/or clogs in petroleum pipelines, storage tanks or other installations. Thus, paraffin precipitation and deposition leads to production downtime resulting in reduced output in oil and gas production and reduced usability of refined petroleum products.

Chemical treatments based on using pour point depressants (PPDs) are commonly used to ensure flow to increase the petroleum and refined petroleum product transportation and productivity. PPDs are additives used to change the rheology of petroleum and/or refined petroleum products to improve their flowability at low temperatures. The efficiency of the additive used as a PPD is attributed to their ability to modify the wax crystals' size and shape and to disperse the paraffin wax. Most PPDs are polymers designed to include nonpolar crystalline segments that are similar to the paraffin chains and segments that include polar moieties. The nonpolar paraffin-like segments interact with wax molecules, whereas the polar moieties are responsible for providing electrostatic repulsion to wax crystals and disorganizing the crystallization process of the wax. However, the effectiveness of PPDs are highly dependent on the composition of the petroleum or refined petroleum product. Thus, a PPD proven to be effective for petroleum from one location may not be effective for petroleum from another location, even from wells within the same field. Similarly, varied refining processes result in disparate wax distributions across refined petroleum products. Developing a specific type of PPD that is universally applicable for diverse fields and finished fuels remains a challenge, which emphasizes the need to have a wide range of polymers for different compositions of petroleum and refined petroleum products.

### SUMMARY

The present disclosure provides for a composition that is less dependent on the makeup of the petroleum or refined petroleum product to be an effective pour point depressant. Specifically, the composition of the present disclosure is more universally applicable to a wide range of petroleum and/or refined petroleum products due to the diversity of functionality in the ethylene acrylic ester terpolymer of the present disclosure. This diversity of functionality in the ethylene acrylic ester terpolymer, as discussed herein, makes this compound more universally effective as a pour point depressant with petroleum or refined petroleum products. Through reactive moieties present on the petroleum and/or refined petroleum product, the composition of the present disclosure can interact with the petroleum and/or refined petroleum product and thereby better act as a universal pour point depressant. Such interactions can include covalent bonds or other interactions such as ionic bonds, van der Waals forces, or hydrogen bonding.

For the various embodiments, the composition of the present disclosure includes (1) a hydrocarbon mixture that can include paraffin wax and at least one reactive moiety; and (2) an ethylene acrylic ester terpolymer. The ethylene acrylic ester terpolymer can include about 5 to about 40 weight % of alkyl acrylate and a moiety reactive with at least one reactive moiety in the hydrocarbon mixture. For the various embodiments, the ethylene acrylic ester terpolymer (e.g., a random or block terpolymer of monomers A/B/C) is formed from (A) a first monomer of ethylene, (B) a second monomer selected from the group consisting of vinyl acetate, alkyl acrylic esters, alkyl (meth)acrylic esters and combinations thereof, and (C) a third monomer having the moiety reactive with at least one reactive moiety in the hydrocarbon mixture. For the various embodiments, the third monomer (C) can be selected from the group consisting of maleic anhydride, maleic acid diesters, glycidyl acrylate, glycidyl methacrylate, glycidyl vinyl ether and combinations thereof. Other possible examples of the third monomer (C) can include carbon monoxide, sulfur dioxide, acrylonitrile, maleic acid monoesters, itaconic acid, fumaric acid, fumaric acid monoesters and combinations thereof of all recited third monomer (C). Salts of the various third monomers (C), where possible, are also included herein.

For the various embodiments, the moiety reactive with at least one reactive moiety in the hydrocarbon mixture is an epoxide group. For example, the third monomer, (C), of the ethylene acrylic ester terpolymer can be selected from the group consisting of glycidyl acrylate, glycidyl methacrylate, glycidyl vinyl ether and combinations thereof. For the various embodiments, the alkyl acrylate can be selected from the group consisting of methyl acrylate, ethyl acrylate, n-butyl acrylate, iso-butyl acrylate, tert-butyl acrylate and combinations thereof.

For the various embodiments, the ethylene acrylic ester terpolymer can be formed from 15 to 40 wt. % of (B), 1 to 25 wt. % of (C) with the remainder being (A). In additional embodiments, the ethylene acrylic ester terpolymer is formed from 5 to 10 wt. % of (C), from 15 to 40 wt. % of (B) with the remainder being (A). In additional embodiments, the ethylene acrylic ester terpolymer has about 10 to about 35 weight % of alkyl acrylate. For the various embodiments, the ethylene acrylic ester terpolymer can be a random terpolymer.

For the various embodiments, the composition can have 10 to 1000 parts per million (ppm) of the ethylene acrylic ester terpolymer based on actives for the hydrocarbon mixture.

For the various embodiments, the hydrocarbon mixture can be selected from the group consisting of petroleum and refined petroleum products, as provided herein. For the various embodiments, the hydrocarbon mixture that includes paraffin wax is a petroleum or a petroleum product, as provided herein.

The present disclosure also includes a method of treating a hydrocarbon mixture that includes paraffin wax and at least one reactive moiety. The method includes providing the ethylene acrylic ester terpolymer having about 5 to about 40 weight % of alkyl acrylate and the moiety reactive with at least one reactive moiety in the hydrocarbon mixture, where the ethylene acrylic ester terpolymer is formed from (A) a first monomer of ethylene, (B) a second monomer selected from the group consisting of vinyl acetate, alkyl acrylic esters, alkyl (meth)acrylic esters and combinations thereof, and (C) a third monomer having the moiety reactive with at least one reactive moiety in the hydrocarbon mixture, the third monomer selected from the group consisting of (C) can be selected from the group consisting of maleic anhydride, maleic acid diesters, glycidyl acrylate, glycidyl methacrylate, glycidyl vinyl ether and combinations thereof; and mixing the ethylene acrylic ester terpolymer with the hydrocarbon mixture that includes paraffin wax and at least one reactive moiety. Other possible examples of the third monomer (C) can include carbon monoxide, sulfur dioxide, acrylonitrile, maleic acid monoesters, itaconic acid, fumaric acid, fumaric acid monoesters and combinations thereof of all recited third monomer (C). Salts of the various third monomers (C), where possible, are also included herein.

### DETAILED DESCRIPTION

The present disclosure provides for a composition that is less dependent on the makeup of the petroleum or refined petroleum product to be an effective pour point depressant. Specifically, the composition of the present disclosure is more universally applicable to a wide range of petroleum and/or refined petroleum products due to the reactive nature of the composition towards the petroleum and/or refined petroleum products. Through reactive moieties present on the petroleum and/or refined petroleum product, the composition of the present disclosure can interact with the petroleum and/or refined petroleum product and thereby better act as a universal pour point depressant.

As used herein, the term “petroleum” includes unprocessed crude oil, synthetic crude oil, sour crude oil and other mixtures of liquids and solids of alkanes, naphthenes, aromatics and asphaltenes.

As used herein, the term “refined petroleum products” include processed crude oil, including refined crude oil products that can include solid petroleum, solid petroleum products, petroleum and petroleum products such as diesel fuel, fuel oil, kerosene, gasoline, heavy fuel oils, marine fuels, and bunker fuels.

The “petroleum” and “refined petroleum products” further include at least one reactive moiety, which is naturally occurring or present in the “petroleum” and/or “refined petroleum products.” For the various embodiments, at least one reactive moiety in the “petroleum” and/or “refined petroleum products” is reactive to an epoxide group. Reactive moieties include those with active hydrogen groups such as amines (both aliphatic/aromatic and primary/secondary), phenols, carboxylic acids, thiols, and anhydrides among others known in the art. In addition, at least one reactive moiety in the “petroleum” and/or “refined petroleum products” can include those moieties that can form not only covalent bonds, as discussed herein, but other interactions or reactions such as ionic bonds, van der Waals forces, or hydrogen bonding with the reactive moiety in the ethylene acrylic ester terpolymer. As such, the reactions between the petroleum and/or the refined petroleum products and the ethylene acrylic ester terpolymer, according to the present disclosure, can include covalent bonds, ionic bonds, van der Waals forces, and/or hydrogen bonding.

As used herein, the term “hydrocarbon mixture” can be selected from the group consisting of petroleum or refined petroleum products, as provided herein, where each such hydrocarbon mixture includes paraffin wax. For the various embodiments, the hydrocarbon mixture that includes paraffin wax can be a petroleum or a petroleum product, as provided herein. As appreciated by one skilled in the art, the petroleum or the petroleum product can be a liquid petroleum or a liquid petroleum product, where at least a portion of the petroleum could also be solid or partially solid at room temperature (e.g., 23° C.).

As used herein, the term “paraffin wax” includes a mixture of hydrocarbons containing from about 10 to about 40 carbon atoms, where the majority of the paraffin wax consists of straight chain saturated hydrocarbons and the remainder as branched paraffins, cycloparaffins, and aromatic paraffins.

For the various embodiments, the composition of the present disclosure includes the hydrocarbon mixture, as provided herein, that includes paraffin wax and at least one reactive moiety, as discussed herein. For the various embodiments, the amount of paraffin wax present in the hydrocarbon mixture, as provided herein, can be up to about 35 percent by total weight of the hydrocarbon mixture.

The composition of the present disclosure further includes an ethylene acrylic ester terpolymer. For the various embodiments, the ethylene acrylic ester terpolymer can include about 5 to about 40 weight % of alkyl acrylate (based on the total weight of the ethylene acrylic ester terpolymer) and a moiety reactive with at least one reactive moiety in the hydrocarbon mixture, as discussed herein. For the various embodiments, the moiety in the ethylene acrylic ester terpolymer reactive with at least one reactive moiety in the hydrocarbon mixture (i.e., the reactive moiety in the ethylene acrylic ester terpolymer that is reactive with at least one reactive moiety in the hydrocarbon mixture) can be, for example, an anhydride, di-acids of an anhydride or epoxide functional groups, as discussed herein. Other reactive moieties are possible. As discussed herein, such reactions between the petroleum and/or the refined petroleum products and the ethylene acrylic ester terpolymer, according to the present disclosure, can include covalent bonds, ionic bonds, van der Waals forces, and/or hydrogen bonding.

In some embodiments, the ethylene acrylic ester terpolymer can include about 15 to about 40 weight % of alkyl acrylate, based on the total weight of the ethylene acrylic ester terpolymer. In additional embodiments, the ethylene acrylic ester terpolymer has about 10 to about 35 weight % of alkyl acrylate, where the wt. % are based on the total weight of the ethylene acrylic ester terpolymer. In other embodiments, the ethylene acrylic ester terpolymer can include about 15 to about 20 weight % of alkyl acrylate, based on the total weight of the ethylene acrylic ester terpolymer. For the various embodiments, the alkyl acrylate can be selected from the group consisting of methyl acrylate, ethyl acrylate, n-butyl acrylate, iso-butyl acrylate, tert-butyl acrylate and combinations thereof.

In more specific embodiments, the ethylene acrylic ester terpolymer (e.g., a random or block terpolymer of monomers A/B/C) is formed from (A) a first monomer of ethylene, (B) a second monomer selected from the group consisting of vinyl acetate, alkyl acrylic esters, alkyl (meth)acrylic esters and combinations thereof, and (C) a third monomer having the moiety reactive with at least one reactive moiety in the hydrocarbon mixture. For the various embodiments, the third monomer (C) can be selected from the group consisting of maleic anhydride, maleic acid diesters, glycidyl acrylate, glycidyl methacrylate, glycidyl vinyl ether and combinations thereof. Other possible examples of the third monomer (C) can include carbon monoxide, sulfur dioxide, acrylonitrile, maleic acid monoesters, itaconic acid, fumaric acid, fumaric acid monoesters and combinations thereof of all recited third monomer (C). Salts of the various third monomers (C), where possible, are also included herein.

For the various embodiments, the term “alkyl acrylic esters” refers to, for example, methyl acrylate, ethyl acrylate, propyl acrylate, isopropyl acrylate, n-butyl acrylate, iso-butyl acrylate, tert-butyl acrylate, n-pentyl acrylate, neopentylacrylate, hexyl acrylate, heptyl acrylate, octyl acrylate, neooctyl acrylate, 2-ethyl hexyl acrylate, nonyl acrylate, neononyl acrylate, decyl acrylate, neodecyl acrylate, lauryl acrylate, palmityl acrylate and stearyl acrylate.

For the various embodiments, the term “alkyl (meth)acrylic esters” refers to, for example, methyl (meth)acrylate, ethyl (meth)acrylate and butyl (meth)acrylate, propyl (meth)acrylate, isopropyl (meth)acrylate, n-butyl (meth)acrylate, s-butyl (meth)acrylate, i-butyl (meth)acrylate, t-butyl (meth)acrylate, pentyl (meth)acrylate, hexyl (meth)acrylate, heptyl (meth)acrylate, octyl (meth)acrylate, 2-ethylhexyl (meth)acrylate, nonyl (meth)acrylate and decyl (meth)acrylate. The term “maleic acid monoester” refers to, for example, maleic anhydride monoethyl ester. The term “maleic acid diesters” refers to, for example, dimethyl maleate, dibutyl maleate, and dioctyl maleate

In preferred embodiments, the third monomer, (C), of the ethylene acrylic ester terpolymer can be selected from the group consisting of glycidyl acrylate, glycidyl methacrylate, glycidyl vinyl ether and combinations thereof. A particularly preferred ethylene acrylic ester terpolymers is composed of (A) monomers of ethylene, (B) vinyl acetate and (C) glycidyl methacrylate. Another particularly preferred ethylene acrylic ester terpolymer is composed of (A) monomers of ethylene, (B) n-butyl acrylate and (C) glycidyl methacrylate.

For the various embodiments, the ethylene acrylic ester terpolymer can be formed from 15 to 40 wt. % of (B), 1 to 25 wt. % of (C) with the remainder being (A), where the wt. % are based on the total weight of the ethylene acrylic ester terpolymer. In an additional embodiment, the ethylene acrylic ester terpolymer can be formed from 15 to 40 wt. % of vinyl acetate for (B), 5 to 10 wt. % of glycidyl methacrylate for (C) with the remainder being (A), where the wt. % are based on the total weight of the ethylene acrylic ester terpolymer. In another embodiment, the ethylene acrylic ester terpolymer can be formed from 20 to 35 wt. % of n-butyl acrylate for (B), 5 to 10 wt. % of glycidyl methacrylate for (C) with the remainder being (A), where the wt. % are based on the total weight of the ethylene acrylic ester terpolymer. For the various embodiments, the ethylene acrylic ester terpolymer can be a random terpolymer.

The ethylene acrylic ester terpolymer of the present disclosure can have a melt index as measured according to ASTM D-1238 at 190° C. and at 2.16 kg from 5 to 150 g/10 minutes, more preferably from 10 to 100 g/10 minutes and most preferably from 25 to 75 g/10 minutes.

The ethylene acrylic ester terpolymer formed from monomers A, B and C, as provided herein, can be prepared by known methods; for example, as described in WO 2005/087868 A1, U.S. Pat. Nos. 5,700,890, 4,351,931, 2,897,183 and/or 3,350,372, among others. Generally, the ethylene acrylic ester terpolymer of A/B/C can be prepared by direct, free-radical, high-pressure copolymerization of the unsaturated monomers. The ethylene acrylic ester terpolymer can be prepared in a stirred high-pressure autoclave, a high-pressure tubular reactor or in a high-pressure stirred reactor or combinations of the two. Suitable pressure conditions for the polymerization are from 100 to 300 MPa, preferably from 150 to 200 MPa. The reaction temperatures are, for example, in the range from 160 to 320° C., preferably in the range from 200 to 280° C. Initiators for the free-radical polymerization can also be used, where examples include organic peroxides, oxygen, azo compounds and mixtures thereof. Examples of useful free-radical initiators include, for example, one or more peroxides selected from the following commercially obtainable substances: lauroyl peroxide, didecanoyl peroxide, 2,5-dimethyl-2,5-di(2-ethylhexanoylperoxy)hexane, tert-amyl peroxy-2-ethylhexanoate, dibenzoyl peroxide, tert-butyl peroxy-2-ethylhexanoate, tert-butyl peroxydiethyl acetate, tert-butyl peroxydiethyl isobutyrate, 1,4-di(tert-butylperoxycarbo)cyclohexane as an isomer mixture, tert-butyl perisononanoate, 1,1-di(tert-butylperoxy)-3,3,5-trimethylcyclo-hexane, 1,1-di(tert-butylperoxy)cyclohexane, methyl isobutyl ketone peroxide, tert-butyl peroxyisopropyl carbonate, 2,2-di-tert-butylperoxy) butane or tert-butyl peroxyacetate; tert-butyl peroxybenzoate, di-tert-amyl peroxide, dicumyl peroxide, the isomeric di(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)hex-3-yne, di-tert-butyl peroxide, 1,3-diisopropyl monohydroperoxide, cumene hydroperoxide or tert-butyl hydroperoxide. Particularly suitable peroxides are di-tert-butyl peroxide, tert-butyl peroxypivalate, tert-butyl peroxyisononanoate or dibenzoyl peroxide or mixtures thereof. An example of an azo compound is azobisisobutyronitrile (AIBN). The free-radical initiators are used in amounts customary for polymerizations.

The rate of addition of (A), (B) and (C) monomers to the reactor will depend on variables such as the polymerization temperature, reactor pressure, the combination along with the concentration of the (A), (B) and (C) monomers needed to achieve the target composition of the ethylene acrylic ester terpolymer. For the various embodiments, the ethylene acrylic ester terpolymer can be continuously removed from the reactor (e.g., the autoclave) and then separated from the unreacted monomers and solvent (if solvent was used) by conventional means, e.g., vaporizing the nonpolymerized materials and solvent under reduced pressure and/or at an elevated temperature.

The present disclosure also includes a method of treating a hydrocarbon mixture, as provided herein, which includes paraffin wax and at least one reactive moiety. The ethylene acrylic ester terpolymer of the present disclosure can be added to, for example, petroleum and/or refined petroleum products, as defined herein, individually or as a mixture of such ethylene acrylic ester terpolymer and optionally in combination with other additives known per se. The method includes providing the ethylene acrylic ester terpolymer, as provided herein, and mixing the ethylene acrylic ester terpolymer with the hydrocarbon mixture that includes paraffin wax and at least one reactive moiety. For the various embodiments, mixing the ethylene acrylic ester terpolymer of the present disclosure with the hydrocarbon mixture having the paraffin wax and at least one reactive moiety can occur at a temperature of 20° C. to 60° C. and at a pressure of 50 to 150 kPa.

For the various embodiments, the mixture of the ethylene acrylic ester terpolymer and the hydrocarbon mixture can have 10 to 1000 parts per million (ppm) of the ethylene acrylic ester terpolymer based on actives for the hydrocarbon mixture. All individual values and subranges from 10 to 1000 ppm of the ethylene acrylic ester terpolymer based on actives for the hydrocarbon mixture are included herein, for example, the mixture of the ethylene acrylic ester terpolymer and the hydrocarbon mixture can have a ppm of the ethylene acrylic ester terpolymer in the mixture based on actives for the hydrocarbon mixture from a lower limit of 10, 20, 50, 100 or 250 to an upper limit of 1000, 900, 800 or 500 ppm of the ethylene acrylic ester terpolymer based on actives for the hydrocarbon mixture. Modifications to this method are of course possible and can be undertaken by those skilled in the art without unreasonable effort.

For the various embodiments, to facilitate mixing with the hydrocarbon mixture the ethylene acrylic ester terpolymer can first be dissolved, for example, in a C4 to C15 solvent, where the solvent can be aromatic, aliphatic or mixtures thereof. Examples of suitable aromatic and aliphatic hydrocarbons and alkoxy alkanols commonly used in the industry, include heptane, hexane, Aromatic 100, Aromatic 150, Aromatic 200, toluene, xylene, or diluent from crude oil processing, such as kerosene, naphtha or brightstock, and combinations thereof. Dissolving the ethylene acrylic ester terpolymer in the C4 to C15 solvent with stirring over 1 to 3 hours. The use of other solvents is also possible.

### EXAMPLES

The examples below are provided to be illustrative only and are not intended to define or limit the embodiments in any way.

In the Examples (Ex) and Comparative Examples (CE), various terms and designations for materials are used including, for instance, the following:

TABLE 1
Materials

| | Chemical | |
|---|---|---|
| Ingredient | Description | Source |
| Aromatic 150 | Heavy C10 | ExxonMobil |
| (A150) | aromatic solvent | |
| | with a flash point | |
| | of 150° F. | |
| Diesel Fuel | Hydrocarbon C9- | Commercial |
| | C25 mixture with a | Source |
| | high proportion of | |
| | iso-paraffins | |
| Conventional crude | | Karamay |
| oil | | Field in |
| | | China |

TABLE 2
EX and CE Compositions

| | | | n-Butyl | Glycidyl | Vinyl | | |
|---|---|---|---|---|---|---|---|
| | | | Acrylate | methacrylate | Acetate | Melt | 0% |
| | | | (nBA) | (GMA) | (VA) | Index | Actives |
| | Comonomer | Ethylene | Content | Content | Content | (dg/ | in |
| Additive | Type | (E) | (wt. %) | (wt. %) | (wt. %) | min) | A150 |
| EX 1 | E/VA/GMA | 78 | — | 7 | 15 | 100 | 5 |
| EX 2 | E/VA/GMA | 74.75 | — | 5.25 | 20 | 12 | 5 |
| EX 3 | E/VA/GMA | 76 | — | 9 | 15 | 8 | 5 |
| EX 4 | E/nBA/GMA | 70 | 21 | 9 | — | 75 | 5 |
| EX 5 | E/nBA/GMA | 59.75- | 33-35 | 5.25 | — | 25 | 5 |
| | | 61.75 | | | | | |
| EX 6 | E/nBA/GMA | 70 | 21 | 9 | — | 8 | 5 |
| EX 7 | E/nBA/GMA | 66.75 | 28 | 5.25 | — | 12 | 5 |
| CE A | E/nBA | 65 | 35 | — | — | 40 | 5 |
| CE B | E/nBA | 73 | 27 | | | 4 | 5 |
| CE C | E/VA | 82 | | | 18 | 150 | 5 |

### Preparation of EX and CE

EX and CE from Table 2 were prepared as follows. EX have an “A/B/C” copolymer structure, while the CE have an “A/B” structure, where A is derived from ethylene, B is derived from either VA or nBA and C is derived from GMA.

The A/B copolymer structures and A/B/C copolymer structures of Table 2 are prepared using a stirred high pressure autoclave reactor (reactor) operating at a temperature of 200° C. and a pressure of 138 MPa. Initially, monomer A is fed to the reactor and polymerization is initiated by lauroyl peroxide (200 ppm) being introduced into the reactor, Once steady state polymerization conditions are established, monomer A or monomers A and B are introduced into the reactor at a constant molar ratio, derived from Table 2. The resulting A/B copolymer structures or A/B/C copolymer structures of Table 2 are discharged from the reactor at the same rate that the monomers are charged to the reactor. The rate of introduction of A, B, and C (when present), the rate of polymerization, and the residence time of the reactants in the reactor are controlled so that a substantially uniform concentration of unpolymerized A monomers and C monomers (when present) are continuously maintained throughout the entire reaction medium.

The A/B copolymer structures or A/B/C copolymer structures exit the reactor through a letdown valve into a separator, where unreacted monomers and liquid A/B copolymer structures or A/B/C copolymer structures are flashed from separator into a second separator. In the second separator the liquid A/B copolymer structures or A/B/C copolymer structures are condensed for use in the Examples herein.

### Preparation of Solvent-Based EX and CE Samples:

Pellets for each copolymer of EX 1-7 and CE A-C copolymer were dissolved in Aromatic 150 (A150) at 5% actives in a four-neck round bottom flask equipped with a mechanical stirrer, thermocouple, and condenser as follows. The comonomer was added to A150 and the comonomer/A150 mixture was heated under a nitrogen blanket to 80° C. for 120 minutes with stirring at 300 rpm. The solvent-based EX and CE samples were cooled to room temperature after complete dissolution of the copolymer pellets.

### Pour Point Depression

The evaluation of the EX and CE as pour point depressant was studied through preparation of diesel samples and conventional crude oil from the Karamay Field in China dosed with different concentrations from each EX and CE (100 and 250 parts per million (ppm) based on actives for diesel, and 50, 100, 250 and 500 ppm for crude oil). To measure the pour point in this application, the Scientifique de Laboratoire MPP SGs Pour Point Analyzer was used, which has high repeatability and reproducibility with a 0.1° C. resolution (ASTM D97). The EX and CE were dosed directly into the diesel fuel samples, which were stirred 1 hour to ensure sample homogeneity before analyzing. The untreated crude oil was first heated to 60° C. in a water bath and shaken well to ensure a homogeneous mixture. A 10 mL sample of the untreated crude oil was added to a 20 mL sample vial with SEPTA cap for formulation and digestion. The appropriate amount of the polymeric additive formulation was added to the 10 mL crude oil sample and shaken well. The vial containing the treated crude oil was then placed in the water bath at 60° C. for one hour. After digestion, the 20 mL sample vial was again shaken well. Empty PPD vials were placed into an aluminum block, which had been previously heated to 60° C. A 0.5 μL sample of the formulation was then dispensed into the pour point vials and capped for pour point measurements. The dosed samples were compared to a blank. For each dosage level, samples were prepared in duplicate. The average of the two points were reported.

The performance testing for each solvated EX and CE in A150 was measured at various additive concentrations (based on actives) and is presented below for each solvated additive in A150 was measured at various additive concentrations (based on actives) in conventional crude oil from the Karamay Field in China (Tables 3-6) and a diesel fuel (Tables 7-8) using pour point analyses. The Karamay Field crude oil has a pour point of 24.0° C. (without additive). The diesel fuel has a pour point of −15.0° C. (without additive).

TABLE 3
Karamay Field Crude Oil at 500 ppm

| Additive | Pour Point Measured (° C.) | Δ in Pour Point |
|---|---|---|
| EX 4 | 19.5 | 4.5 |
| EX 5 | 15.0 | 9.0 |
| EX 6 | 21.0 | 3.0 |
| EX 7 | 21.0 | 3.0 |
| CE A | 22.5 | 1.5 |

EX 5 depressed the pour point by 9° C. at 500 ppm whereas CE A only lowered the pour point by 1.5 C.

TABLE 4
Karamay Field Crude Oil at 250 ppm

| Additive | Pour Point Measured (° C.) | Δ in Pour Point |
|---|---|---|
| EX 4 | 15.0 | 9.0 |
| EX 5 | 15.0 | 9.0 |
| CE A | 21.0 | 3.0 |

EX 4 and Ex 5 depressed the pour point by 9° C. at 250 ppm whereas CE A only lowered the pour point by 3° C.

TABLE 5
Karamay Field Crude Oil at 100 ppm

| Additive | Pour Point Measured (° C.) | Δ in Pour Point |
|---|---|---|
| EX 1 | 18.0 | 6.0 |
| EX 4 | 15.0 | 9.0 |
| EX 5 | 15.0 | 9.0 |
| CE A | 21.0 | 3.0 |
| CE C | 21.0 | 3.0 |

EX 4 and EX 5 depressed the pour point by 9° C. at 100 ppm whereas CE A and CE C only lowered the pour point by 3° C.

TABLE 6
Karamay Field Crude Oil at 50 ppm

| Additive | Pour Point Measured (° C.) | Δ in Pour Point |
|---|---|---|
| EX 1 | 13.5 | 10.5 |
| EX 7 | 9.0 | 15.0 |
| CE A | 15.0 | 9.0 |
| CE C | 21.0 | 3.0 |

EX 1 depressed the pour point by 10.5° C. at 50 ppm whereas CE C only lowered the pour point by 3 C. EX 7 depressed the pour point by 15° C. at 50 ppm whereas CE only lowered the pour point by 9° C.

TABLE 7
Diesel Fuel at 250 ppm

| Additive | Pour Point Measured (° C.) | Δ in Pour Point |
|---|---|---|
| EX 1 | −27.0 | 12.0 |
| EX 2 | −24.0 | 9.0 |
| EX 3 | −24.0 | 9.0 |
| EX 4 | −27.0 | 12.0 |
| EX 5 | −30.0 | 15.0 |
| EX 6 | −24.0 | 9.0 |
| CE B | −22.5 | 7.5 |

EX 1 and EX 4 depressed the pour point by 12.0° C. and EX 5 depressed the pour point by 15.0° C. at 250 ppm whereas CE B only lowered the pour point by 7.5° C.

TABLE 8
Diesel Fuel at 100 ppm

| Additive | Pour Point Measured (° C.) | Δ in Pour Point |
|---|---|---|
| EX 1 | −24.0 | 9.0 |
| EX 2 | −4.0 | 9.0 |
| EX 4 | −24.0 | 9.0 |
| EX 5 | −30.0 | 15.0 |
| EX 6 | −24.0 | 9.0 |
| CE B | −22.5 | 7.5 |

EX 5 depressed the pour point by 15.0° C. at 100 ppm whereas CE B only lowered the pour point by 7.5° C.

The results compiled in Tables 3-8 demonstrate good performance of the EX polymeric additives (5% actives in A150) used in accordance with the invention as pour point depressants in conventional crude oil and diesel fuel compositions.

1. A composition, comprising:
a hydrocarbon mixture that includes paraffin wax and at least one reactive moiety; and
an ethylene acrylic ester terpolymer having about 5 to about 40 weight % of alkyl acrylate and a moiety reactive with at least one reactive moiety in the hydrocarbon mixture, wherein the ethylene acrylic ester terpolymer is formed from (A) a first monomer of ethylene, (B) a second monomer selected from the group consisting of vinyl acetate, alkyl acrylic esters, alkyl (meth)acrylic esters and combinations thereof, and (C) a third monomer having the moiety reactive with at least one reactive moiety in the hydrocarbon mixture, the third monomer selected from the group consisting of maleic anhydride, maleic acid diesters, glycidyl acrylate, glycidyl methacrylate, glycidyl vinyl ether and combinations thereof.

2. The composition of claim 1, wherein (C) is selected from the group consisting of glycidyl acrylate, glycidyl methacrylate, glycidyl vinyl ether and combinations thereof.

3. The composition of claim 1, wherein the ethylene acrylic ester terpolymer is formed from 15 to 40 wt. % of (B), 1 to 25 wt. % of (C) with the remainder being (A).

4. The composition of claim 3, wherein the ethylene acrylic ester terpolymer is formed from 5 to 10 wt. % of (C).

5. The composition of claim 1, wherein the alkyl acrylate is selected from the group consisting of methyl acrylate, ethyl acrylate, n-butyl acrylate, iso-butyl acrylate, tert-butyl acrylate and combinations thereof.

6. The composition of claim 1, wherein the composition has 10 to 1000 parts per million (ppm) of the ethylene acrylic ester terpolymer based on actives for the hydrocarbon mixture.

7. The composition of any one of claims 1-6, wherein the ethylene acrylic ester terpolymer is a random terpolymer.

8. The composition of claim 1, wherein the moiety reactive with at least one reactive moiety in the hydrocarbon mixture is an epoxide group.

9. The composition of claim 1, wherein the hydrocarbon mixture that includes paraffin wax is a petroleum or a petroleum product.

10. The composition of claim 1, wherein the ethylene acrylic ester terpolymer has about 10 to about 35 weight % of alkyl acrylate.

11. A method of treating a hydrocarbon mixture that includes paraffin wax and at least one reactive moiety, comprising:
providing an ethylene acrylic ester terpolymer having about 5 to about 40 weight % of alkyl acrylate and a moiety reactive with at least one reactive moiety in the hydrocarbon mixture, wherein the ethylene acrylic ester terpolymer is formed from (A) a first monomer of ethylene, (B) a second monomer selected from the group consisting of vinyl acetate, alkyl acrylic esters, alkyl (meth)acrylic esters and combinations thereof, and (C) a third monomer having the moiety reactive with at least one reactive moiety in the hydrocarbon mixture, the third monomer selected from the group consisting of maleic anhydride, maleic acid diesters, glycidyl acrylate, glycidyl methacrylate, glycidyl vinyl ether and combinations thereof; and
mixing the ethylene acrylic ester terpolymer with the hydrocarbon mixture that includes paraffin wax and at least one reactive moiety.
